(19) United States
(12) Patent Application Publication
(10) Pub. No.: US 2017/0163063 A1
(43) Pub. Date: Jun. 8, 2017

(54) PORTABLE PHONE CHARGER WITH AUXILIARY FUNCTIONS

(71) Applicant: Yong-Yue Cai, Nin-Bo City (CN)

(72) Inventor: Yong-Yue Cai, Nin-Bo City (CN)

(21) Appl. No.: 14/956,536

(22) Filed: Dec. 2, 2015

(51) Int. Cl. H02J 7/00

(52) U.S. Cl. CPC H02J 7/0045

(57) ABSTRACT

A portable phone charger includes a charger body formed with at least two sockets of different sizes for receiving plugs of two different electronic devices to be charged; a phone support fastened movably to the charger body so as to be movable between a storage position, in which, the phone support is received within the charger body and a used position, in which, the phone support is extended outwardly from the charger body to support a phone thereon together with the charger body; and a hanger connected to the charger body and adapted to be hung on an object to prevent displacement of the charger body.

### BACKGROUND OF THE INVENTION

1. Field of the Invention

The present invention relates to a phone charger, more particularly to a portable phone charger with auxiliary functions in addition to battery charging performance.

2. The Prior Arts

Mobile telephones for automobiles became available from some telephone companies in the 1940s, but it was not until the mid 1980s that they became widely available. The earlier mobile phones are bulky in size and are used for talking only, hence the batteries employed therein last for several days, even weeks. In those days, the mobile phone is generally kept in a waiting mode most of the time, which consumes a little power and only when the mobile phone is in a talking mode, the battery power is consumed.

Invention of smart phones and prevalent of mobile phones today change the daily habits of modern people, since majority of people rely heavily on mobile phones or smart phones and they cannot do without the mobile phones, because their daily life requires the assistance of mobile phones. For instance, the massive amount of email checking, texting, transmission of messages to and fro, mobile gaming, internet surfing and financial transaction for business are done via the mobile phones. Some even watch the movie over their smart phones. Hence, it is a common knowledge that the more you use your mobile phone, the faster the battery runs out. Once, the battery runs out, the mobile phone becomes a useless gadget, unless it is immediately charged. We all know that charging battery can be done only at homes or locations, where wall outlets connected with home electrical power source are available, which is very inconvenient for the mobile phone users.

The urgent needing of battery power for mobile phones away from homes and offices leads to this invention of a portable phone charger. Today, portable phone chargers are available in different forms or configurations in the market, the prices of which differ depending on the battery charging power and the materials from which the portable phone chargers are manufactured. However, the majority of portable phone chargers only concentrate on battery charging process, some auxiliary functions or necessary functions are neglected.

It is noted that some mobile phone users feel tremendously disgusted or annoyed, if their mobile phones run out of battery, especially when watching a movie, which is broadcasted in serial number over the smart phones or when they are conducting financial transaction for businesses. This problem can be avoided if the portable phone charger is provided with auxiliary functions in addition to the battery charging operation.

### SUMMARY OF THE INVENTION

Therefore, the objective of the present invention is to provide a portable phone charger that possesses auxiliary functions to eliminate the above-mentioned problems.

Another objective of the present invention is to provide a portable phone charger that possesses a hanger which can be hung onto an object in order to avoid the problem of being misplacing the portable phone charger of the present invention such that the portable phone charger can be easily found when the mobile phone needs charging.

A portable phone charger with auxiliary functions of the present invention includes a charger body, a phone support and a hanger. The charger body is formed with at least two sockets of different sizes for receiving plugs of two different electronic devices to be charged. The phone support is fastened movably to the charger body so as to be movable between a storage position, in which, the phone support is received within the charger body and a used position, in which, the phone support is extended outwardly from the charger body to support a mobile phone thereon together with the charger body. The hanger is connected to the charger body and is adapted to be hung on an object to prevent displacement of the charger body.

Preferably, the two sockets of different sizes include one USB port and one micro USB port which are standard specifications of majority of the mobile phones to be charged.

In one embodiment of the present invention, the charger body has an end plate. The phone support includes a slidable portion connected slidably with the end plate and a phone limit portion extending transversely from a free end of the slidable portion so as form an acute angle therebetween.

In the portable phone charger of the present invention, the end plate has a lower section formed with an elongated slot to receive slidably the slidable portion and an upper section formed with a rectangular opening in spatial communication with the slot to receive the phone limit portion, when the phone support is disposed in the storage position.

It is to note that when the phone support is disposed in the storage position, the phone limit portion is flush with the end plate while the slidable portion is received in the slot in the end plate.

Another thing to note is that when the phone support is disposed in the used position, the phone limit portion extends in parallel relative to the end plate so as to define a phone-reception space therebetween to receive a mobile phone in the phone reception space, where the mobile phone is in use, such as charging the battery or the user is watching a movie or a video play being displayed in the display panel of the mobile phone.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view of a portable phone charger of the present with auxiliary functions;

FIG. 2 shows a perspective view of the portable phone charger of the present with auxiliary functions from another angle;

FIG. 3 shows a lateral side view of the portable phone charger of the present with auxiliary functions;

FIGS. 4, 5 and 6 respectively show perspective, lateral side and top planar views of the portable phone charger of the present invention, illustrating a phone support is extended outwardly from a charger body ready for use; and

FIGS. 7A, 7B, 7C and 7D respectively show perspective, lateral side, top planar and front views of the portable phone charger of the present invention, illustrating the phone support being extended outwardly from the charger body in a used position.

### DETAILED DESCRIPTION OF THE PREFERRED EMBODIMENT

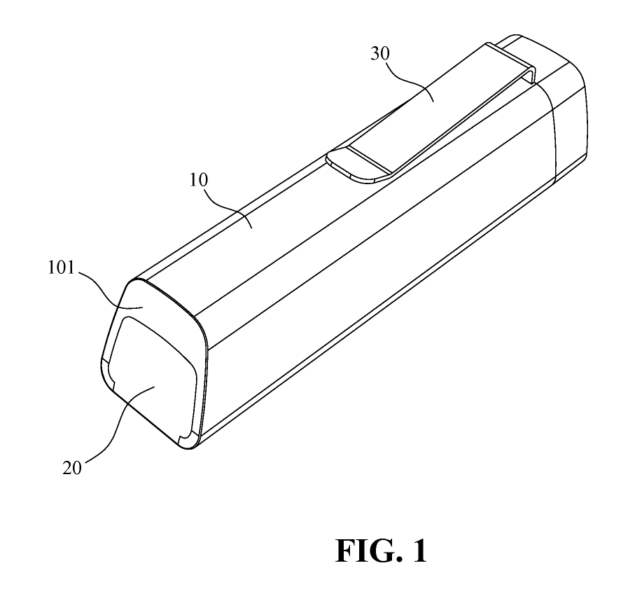

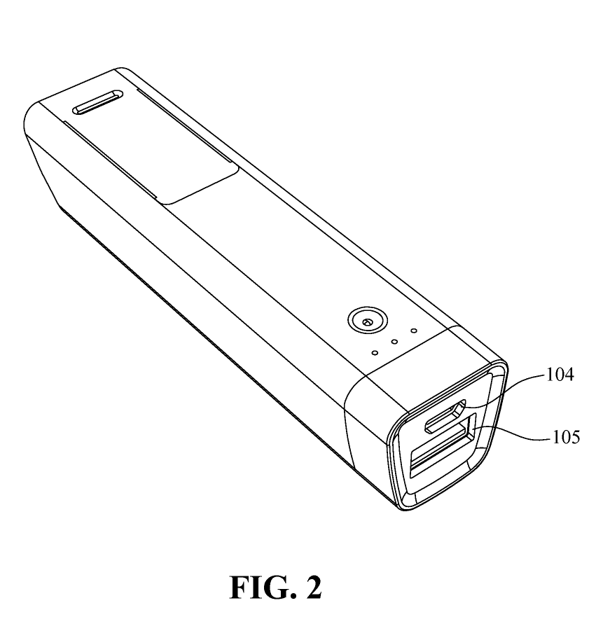

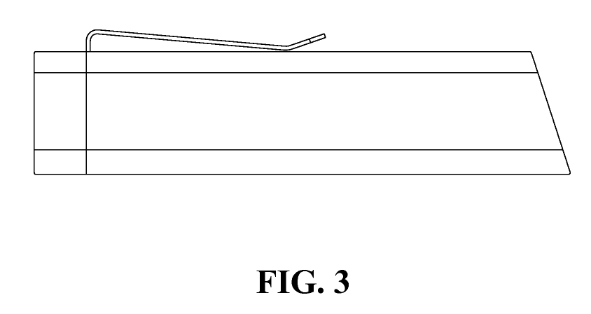

Referring to FIGS. 1 to 3, wherein FIG. 1 shows a perspective view of a portable phone charger of the present with auxiliary functions; FIG. 2 shows a perspective view of the portable phone charger of the present with auxiliary functions from another angle; and FIG. 3 shows a lateral side view of the portable phone charger of the present with auxiliary functions. As illustrated, a portable phone charger 1 of the present invention with auxiliary functions includes a charger body 10, a phone support 20 and a hanger 30.

The charger body 10 is formed with at least two sockets 104, 105 of different sizes at a rear end thereof for receiving plugs of two different electronic devices to be charged (see FIG. 2). Preferably, the two sockets 104, 105 of different sizes include one USB port and one micro USB port, which are commonly employed in modern mobile phones for performance of electrical connections. Though, USB port and one micro USB port of standard specifications are used in the portable phone chargers of the present invention, other connection ports of different specifications can be employed so long as electrical connection can be established between the portable phone charger of the present invention with the peripheral electronic devices.

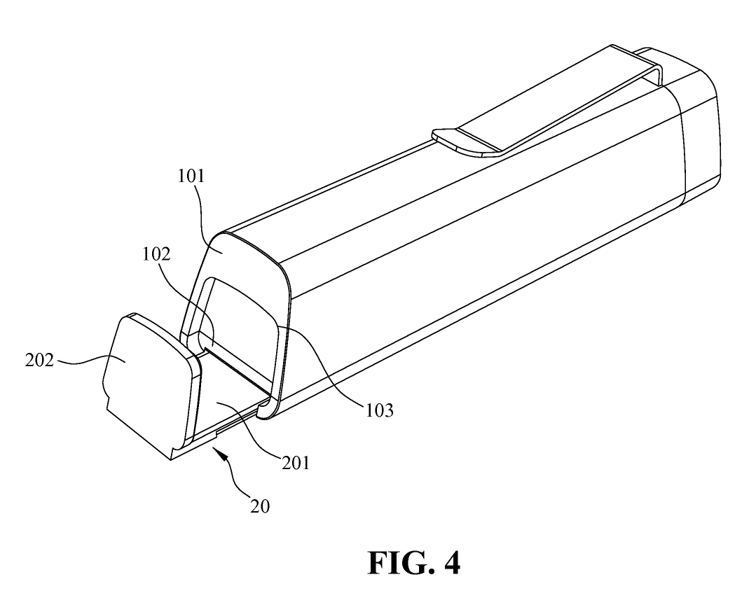

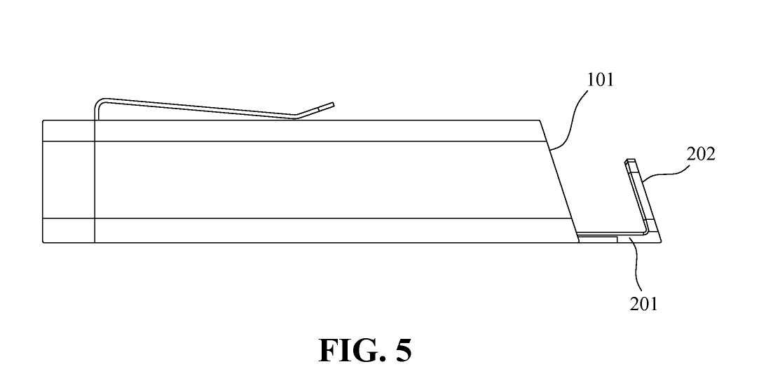

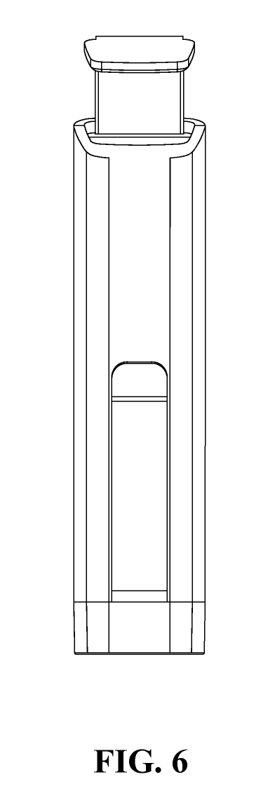

The phone support 20 is fastened movably to the charger body 10 so as to be movable between a storage position, in which, the phone support 20 is received within the charger body 10 (see FIG. 1), and a used position, in which, the phone support 20 is extended outwardly from the charger body 10 to support a smart phone thereon together with the charger body (see FIGS. 4, 5 and 6). In this embodiment, the charger body 10 has a front end plate 101. The phone support 20 preferably includes a slidable portion 201 connected slidably with the end plate 101 and a phone limit portion 202 extending transversely from a free end of the slidable portion 201 so as form an acute angle therebetween. To be more specific, the end plate 101 inclined with respect to the slidable portion 201, has a lower section formed with a slot 102 (see FIG. 4) to receive slidably the slidable portion 201 and an upper section formed with a rectangular opening 103 in spatial communication with the slot 102 to receive the phone limit portion 202 when the phone support 20 is disposed in the storage position, as best shown in FIG. 1. Note that when the phone support 20 is disposed in the storage position, the phone limit portion 202 is flush with the end plate 101 of the charger body 1.

The hanger 30 is connected to the charger body 10, and is adapted to be hung on an object (like a user's belt or a lady's bag) to prevent displacement of the charger body 1 such that whenever the mobile phone is required to be charged, the portable phone charger of the present invention can be easily located to facilitate the battery charging operation.

One distinct feature of the portable phone charger of the present invention resides in that in the used position (for battery charging), the phone support 20 can be extended outwardly from the charger body 10 to desired length such that the phone limit portion 202 extends in parallel relative to the end plate 101 so as to define a variable phone reception space between the phone limit portion 202 and the front end plate 101 of the charger body 1, mobile phones of different thicknesses or sizes can be accommodated in the phone reception space.

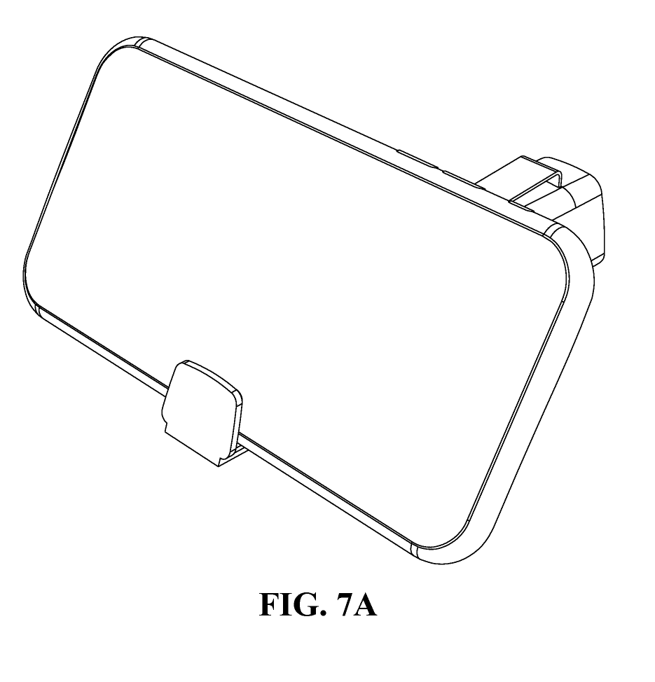

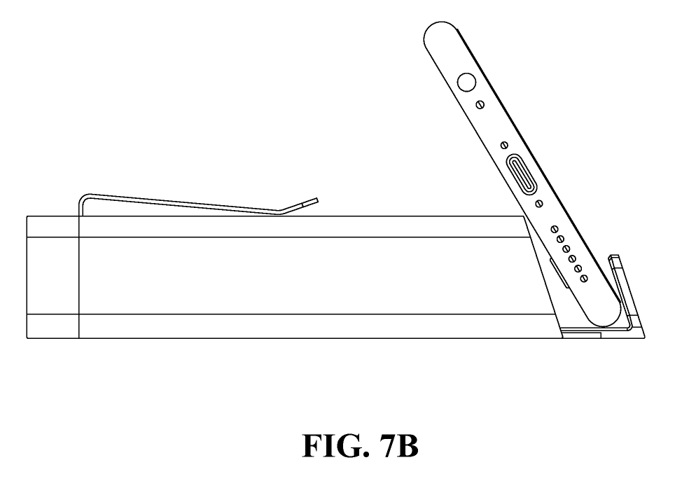

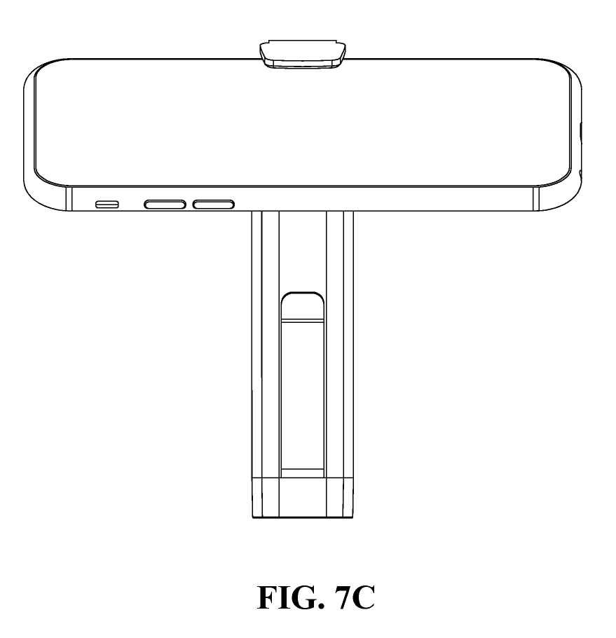

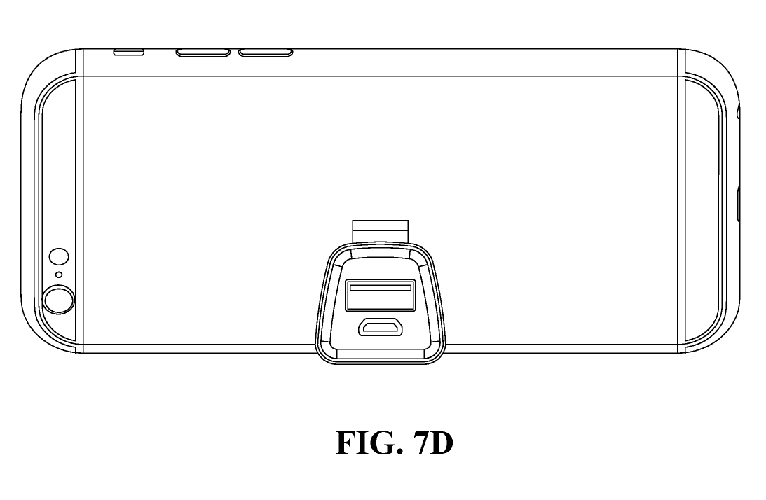

FIGS. 7A, 7B, 7C and 7D respectively show perspective, lateral side, top planar and front views of the portable phone charger 1 of the present invention, illustrating the phone support 20 is extended outwardly from the charger body 1 in the used position. As shown, the mobile phones are disposed at different angles relative to the charger body 1 to facilitate watching of the display panel of the mobile phones even if the latter are being charged.

Another aspect to note is that utilization of hanger 30 permits the portable phone charger of the present invention to be hung on a user's bag or a lady bag, the portable phone charger can be easily located upon requirement, thereby providing convenience to the mobile phone users.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A portable phone charger comprising:
a charger body formed with at least two sockets of different sizes for receiving plugs of two different electronic devices to be charged;
a phone support fastened movably to said charger body so as to be movable between a storage position, in which, said phone support is received within said charger body and a used position, in which, said phone support is extended outwardly from said charger body to support a smart phone thereon together with said charger body; and
a hanger connected to said charger body and adapted to be hung on an object to prevent displacement of said charger body.

2. The portable phone charger according to claim 1, wherein said two sockets of different sizes include one USB port and one micro USB port.

3. The portable phone charger according to claim 1, wherein said charger body has an end plate, said phone support including a slidable portion connected slidably with said end plate and a phone limit portion extending transversely from a free end of said slidable portion so as form an acute angle therebetween.

4. The portable phone charger according to claim 1, wherein said end plate is inclined with respect to the slidable portion, has a lower section formed with a slot to receive slidably said slidable portion and an upper section formed with a rectangular opening in spatial communication with said slot to receive said phone limit portion when said phone support is disposed in said storage position.

5. The portable phone charger according to claim 4, wherein when said phone support is disposed in said storage position, said phone limit portion is flush with said end plate.

6. The portable phone charger according to claim 3, wherein when said phone support is disposed in said used position, said phone limit portion extends parallelly relative to said end plate so as to define a phone-reception space therebetween to receive a cell phone in said phone reception space.
